(19) United States
(12) Patent Application Publication
(10) Pub. No.: US 2016/0050325 A1
(43) Pub. Date: Feb. 18, 2016

(54) IMAGE READING APPARATUS, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Miki ONITSUKA, Kanagawa (JP)

(73) Assignee: FUJI XEROX CO., LTD., Tokyo (JP)

(21) Appl. No.: 14/605,056

(22) Filed: Jan. 26, 2015

(30) Foreign Application Priority Data
Aug. 14, 2014 (JP) 2014-165241

(51) Int. Cl. H04N 1/00; H04N 1/21

(52) U.S. Cl. CPC H04N 1/00214; H04N 1/00795; H04N 1/2166

(57) ABSTRACT

An image reading apparatus includes the following elements. A reading unit reads an image from a recording medium. An obtaining unit obtains a character string input by an operator. A display unit displays plural items of identification information for identifying plural candidates of a destination to which the image is sent and displays, upon obtaining the character string, at least one item of identification information including the character string, instead of displaying the plural items of identification information. A sending unit sends the image to a destination identified by an item of identification information set by the operator. Each of the plural items of identification information includes a network name and a computer name of plural levels of a hierarchy, and the display unit displays identification information including a network name or a computer name of one of the levels of the hierarchy which includes the character string.

### CROSS-REFERENCE TO RELATED APPLICATIONS

This application is based on and claims priority under 35 USC 119 from Japanese Patent Application No. 2014-165241 filed Aug. 14, 2014.

### BACKGROUND

### Technical Field

The present invention relates to an image reading apparatus, an information processing apparatus, and a non-transitory computer readable medium.

### SUMMARY

According to an aspect of the invention, there is provided an image reading apparatus including: a reading unit that reads an image from a recording medium on which the image is recorded; an obtaining unit that obtains a character string input by an operator; a display unit that displays plural items of identification information for identifying plural candidates of a destination to which the image is sent and that displays, upon obtaining the character string, at least one item of identification information including the character string, instead of displaying the plural items of identification information; and a sending unit that sends the image to a destination identified by an item of identification information set by the operator among the at least one item of identification information. Each of the plural items of identification information includes a network name and a computer name of plural levels of a hierarchy. The display unit displays identification information including a network name or a computer name of one of the levels of the hierarchy which includes the character string, as the at least one item of identification information.

### BRIEF DESCRIPTION OF THE DRAWINGS

An exemplary embodiment of the present invention will be described in detail based on the following figures, wherein:

FIG. 1 illustrates an example of the overall configuration of an image reading system to which an exemplary embodiment is applied;

FIG. 2 is a block diagram illustrating an example of the hardware configuration of an image reading apparatus of an exemplary embodiment;

FIG. 3 illustrates an example of a screen for specifying a terminal device;

FIG. 4 illustrates a display example of a network reference mode screen in which a character string is not input in a storage destination input field;

FIG. 5 illustrates a display example of a network reference mode screen in which a character string including “¥¥” is input in a storage destination input field;

FIG. 6 illustrates a display example of a network reference mode screen in which a network name has been selected from a list of network names displayed in a terminal list display field;

FIG. 7 illustrates a display example of a network reference mode screen in which a character string without “¥” is input in a storage destination input field;

FIG. 8 is a block diagram illustrating an example of the functional configuration of a storage destination decision assisting device according to an exemplary embodiment;

FIG. 9 illustrates an example of a terminal list stored in a terminal list storage unit;

FIG. 10 is a flowchart illustrating an example of an operation for creating a terminal list by the storage destination decision assisting device according to an exemplary embodiment; and

FIG. 11 is a flowchart illustrating an example of an operation for using a terminal list by the storage destination decision assisting device according to an exemplary embodiment.

### DETAILED DESCRIPTION

An exemplary embodiment of the invention will be described below in detail with reference to the accompanying drawings.

### [Overall Configuration of Image Reading System]

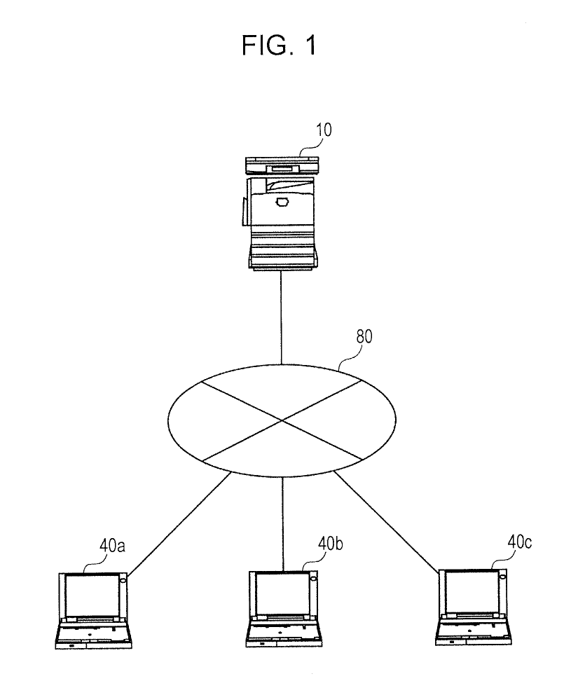

FIG. 1 illustrates an example of the overall configuration of an image reading system to which an exemplary embodiment is applied. As shown in FIG. 1, the image reading system is formed by connecting an image reading apparatus 10 and terminal devices 40a through 40c to each other via a communication network 80. Although the individual terminal devices 40a through 40c are shown in FIG. 1, they will be collectively referred to as “a terminal device 40” or “terminal devices 40” unless it is necessary to distinguish from each other. Although only three terminal devices 40 are shown in FIG. 1, four or more terminal devices 40 may be provided.

The image reading apparatus 10 reads an image from a recording medium, such as paper, on which an image is recorded. The read image is stored in the image reading apparatus 10 or is sent to a terminal device 40 as image data. The image reading apparatus 10 may be an apparatus having a mere scanner function for reading an image from a recording medium. However, a description will be given below, assuming that the image reading apparatus 10 also has a printer function for forming an image on a recording medium and a fax function for sending and receiving image data.

The terminal device 40 is a computer storing image data sent from the image reading apparatus 10.

The communication network 80 is a communication medium used for performing information communication between the image reading apparatus 10 and the terminal device 40. The communication network 80 is, for example, the Internet.

### [Hardware Configuration of Image Reading Apparatus]

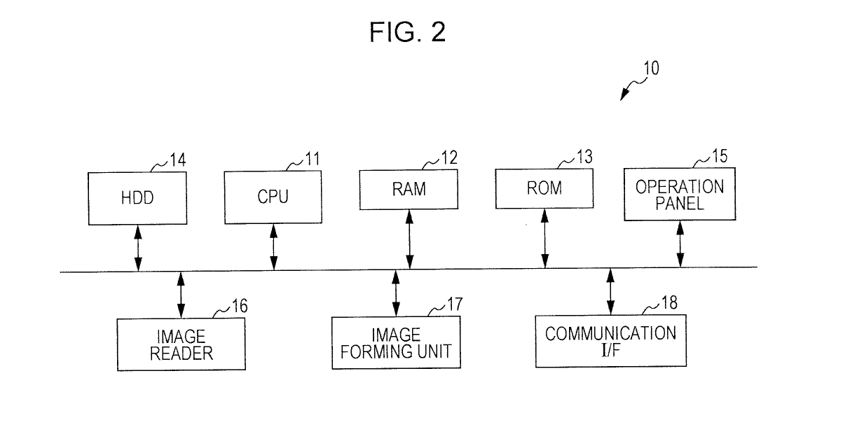

FIG. 2 is a block diagram illustrating an example of the hardware configuration of the image reading apparatus 10 of this exemplary embodiment. As shown in FIG. 2, the image reading apparatus 10 includes a central processing unit (CPU) 11, a random access memory (RAM) 12, a read only memory (ROM) 13, a hard disk drive (HDD) 14, an operation panel 15, an image reader 16, an image forming unit 17, and a communication interface (hereinafter will be referred to as the “communication I/F”) 18.

The CPU 11 loads various programs stored in, for example, the ROM 13, into the RAM 12 and executes them so as to implement various functions, which will be discussed later.

The RAM 12 is a memory used as, for example, a work memory for the CPU 11.

The ROM 13 is a memory storing various programs executed by the CPU 11 therein.

The HDD 14 is a device storing therein image data read by the image reader 16 and image data representing an image to be formed by the image forming unit 17. The HDD 14 is, for example, a magnetic disk drive.

The operation panel 15 is a device that displays various items of information and receives operations from a user. The operation panel 15 is, for example, a touch panel. In this example, the operation panel 15 is constituted by a display on which various items of information are displayed and a position detection sheet which detects a position specified by, for example, a finger or a stylus pen. Alternatively, a display and a keyboard may be used instead of a touch panel.

The image reader 16 is an example of a reading unit. The image reader 16 reads an image recorded on a recording medium, such as paper. The image reader 16 is, for example, a scanner, and may be a charge coupled device (CCD) scanner or a contact image sensor (CIS) scanner. In a CCD scanner, light applied to a document from a light source and reflected by the document is reduced by a lens and is received by CCDs. In a CIS scanner, light sequentially applied to a document from light emitting diode (LED) light sources and reflected by the document is received by a CIS.

The image forming unit 17 forms an image on a recording medium. The image forming unit 17 is, for example, a printer for forming an image by using an electrophotographic system or an inkjet method. In the electrophotographic system, an image is formed by transferring toner attached to a photoconductor drum to a recording medium. In the inkjet method, an image is formed by ejecting ink onto a recording medium.

The communication I/F 18 is an example of a sending unit, and sends and receives various items of information to and from other devices via the communication network 80.

### [Knowledge Forming Basis of Exemplary Embodiment]

A user may wish to transfer image data read by the image reading apparatus 10 to a terminal device 40 which is not registered in an address book stored in the image reading apparatus 10, by using a server message block (SMB) protocol. In this case, generally, the user searches for the target device 40 by tracing the hierarchy by using a list displayed by network browsing. More specifically, the image reading apparatus 10 obtains information managed by a master browser by broadcasting and displays the obtained information as a list. In this state, when the user selects one network from the list, the image reading apparatus 10 obtains information concerning terminal devices 40 belonging to the selected network, and displays the obtained information.

However, if many terminal devices 40 are found, it takes time to search for the target terminal device 40 since the number of devices that can be displayed in the list at one time is limited. If the target terminal device 40 does not exist in the selected network, for displaying terminal devices 40 belonging to another network, the user has to return to the previous level of the hierarchy and obtain information again. If the user does not know a full path in the first place, the user is even unable to select the target terminal device 40.

Accordingly, in this exemplary embodiment, even if a user does not have definite information concerning a terminal device 40 which will store image data read by the image reading apparatus 10, the user is able to select this terminal device 40. In this case, terminal devices 40 that are considered to be physically located near the user can be searched for.

### [Overview of Exemplary Embodiment]

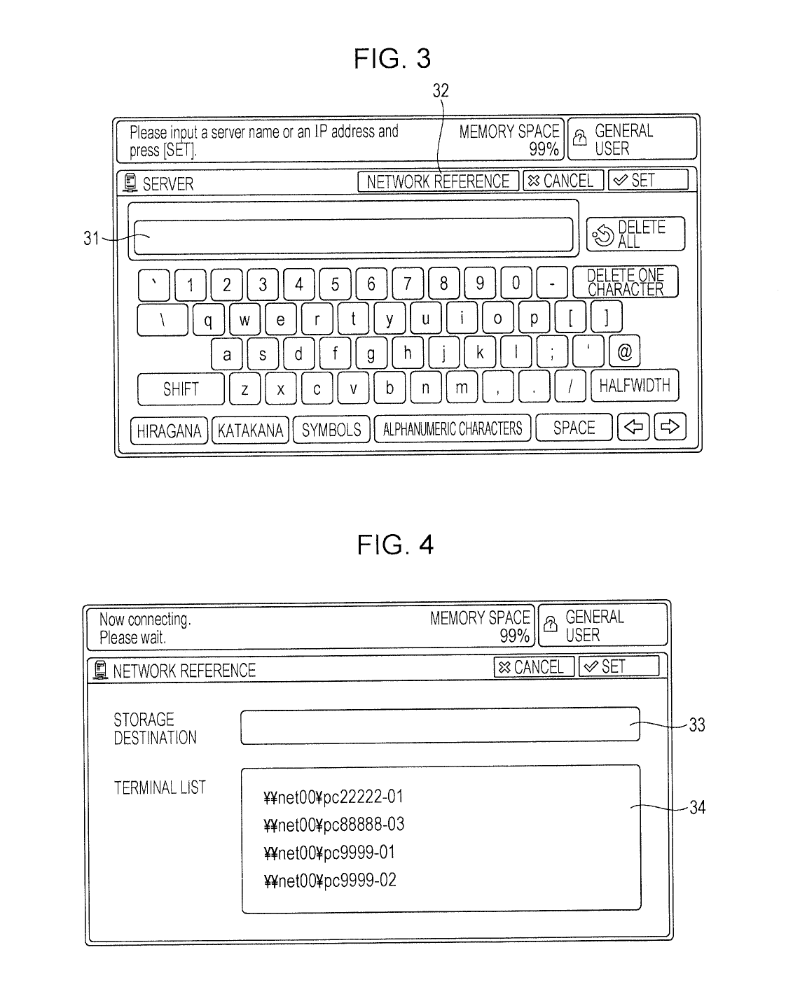

FIG. 3 illustrates an example of a screen for specifying a terminal device 40 displayed on the operation panel 15 of the image reading apparatus 10. In this screen, by directly inputting a server name or an Internet protocol (IP) address in a server-name/IP-address input field 31, a terminal device 40 is specified. In this screen, if a user presses a network reference button 32, this screen is switched to a network reference mode screen implementing a network reference mode in which the user can specify a terminal device 40 while referring to a network. Alternatively, the network reference mode screen may appear as a default.

FIG. 4 illustrates a display example of the network reference mode screen displayed on the operation panel 15 in the network reference mode. In this example, a character string is not input in a storage destination input field 33. In this case, the image reading apparatus 10 displays terminal path names (network names and computer names) included in a terminal list (which will be discussed later) stored in the image reading apparatus 10 in a terminal list display field 34. In this case, the terminal path names are displayed in order in which they are in the terminal list. In this screen, the user inputs a character string in the storage destination input field 33. When inputting a character string in the storage destination input field 33, there is a case in which a character string with “¥¥” is input and a case in which a character string without “¥” is input.

A case in which a character string with “¥¥” is input will first be discussed.

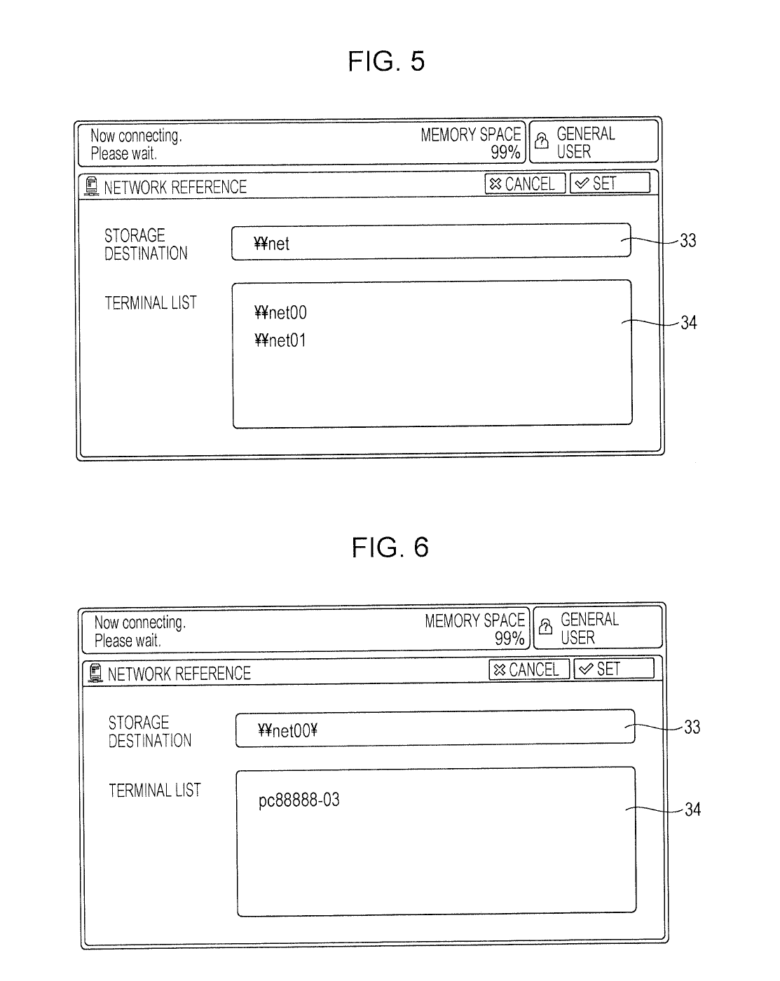

FIG. 5 illustrates a display example of the network reference mode screen in which a character string with “¥¥” is input in the storage destination input field 33. If a character string with “¥¥” is input, the image reading apparatus 10 recognizes that this character string is a network name at the highest level of the hierarchy in “¥¥network_name¥computer_name¥share_name” or “¥¥network_name¥computer_name¥share_name¥path_name”. In FIG. 5, the user has input “¥¥net” in the storage destination input field 33 as an example. Then, the image reading apparatus 10 displays network names starting with “net” in a terminal list display field 34.

FIG. 6 illustrates a display example of the network reference mode screen when a target network name has been selected from a list of network names displayed in the terminal list display field 34. In FIG. 6, the user has selected “¥¥net00” from the network names displayed in the terminal list display field 34 as an example. Then, the image reading apparatus 10 complements the storage destination address displayed in the storage destination input field 33 with “00”, and displays “pc88888-03” as a computer name following “¥¥net00” in the terminal list display field 34. This enables the user to select the computer name displayed in the terminal list display field 34 as the target computer name. Alternatively, if plural computer names are displayed in the terminal list display field 34 as computer names following “¥¥net00” although they are not shown, the image reading apparatus 10 may refine a search result, and then, the user may select a target computer name. For example, if the user inputs “¥pc8888” in the storage destination input field 33, the image reading apparatus 10 may restrict plural computer names into “pc88888-03” starting with “pc8888”.

Then, a case in which a character string without “¥” is input will be discussed below.

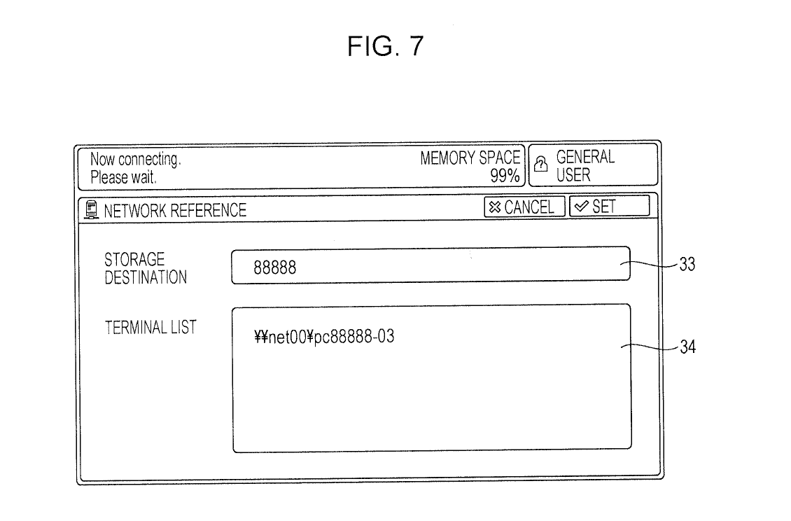

FIG. 7 illustrates a display example of the network reference mode screen in which a character string without “¥” is input in the storage destination input field 33. If a character string without “¥” is input, the image reading apparatus 10 searches for computer names including this character string at any of the levels of the hierarchy. In FIG. 7, the user has input “88888” in the storage destination input field 33 as an example. Then, the image reading apparatus 10 searches for “88888” from all the levels of the hierarchy, and displays “pc88888-03” belonging to “net00” in the terminal list display field 34. This enables the user to select the computer name displayed in the terminal list display field 34 as the target computer name.

### [Functional Configuration of Storage Destination Decision Assisting Device]

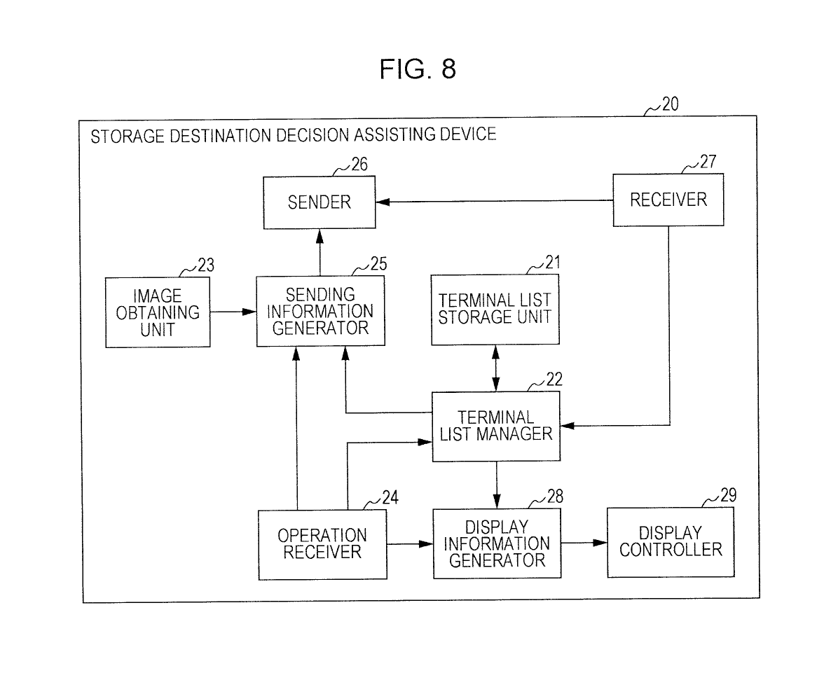

FIG. 8 is a block diagram illustrating an example of the functional configuration of a storage destination decision assisting device 20 for assisting the decision of a storage destination of image data by displaying the above-described screens. The storage destination decision assisting device 20 is an example of an information processing apparatus, and is implemented as a result of the CPU 11 (see FIG. 2) of the image reading apparatus 10 reading a program implementing the individual function units, which will be discussed below, from the ROM 13 (see FIG. 2) into the RAM 12 (see FIG. 2) and executing the program.

As shown in FIG. 8, the storage destination decision assisting device 20 includes a terminal list storage unit 21, a terminal list manager 22, an image obtaining unit 23, an operation receiver 24, a sending information generator 25, a sender 26, a receiver 27, a display information generator 28, and a display controller 29.

The terminal list storage unit 21 stores therein a terminal list indicating information concerning a predetermined number of terminal devices 40. Details of the terminal list will be discussed later.

The terminal list manager 22 manages a terminal list stored in the terminal list storage unit 21. More specifically, as a result of the receiver 27 receiving a terminal path name and an IP address, the terminal list manager 22 creates a terminal list to be stored in the terminal list storage unit 21, on the basis of the received terminal path name and IP address. Upon receiving information that a user operation for displaying the network reference mode screen has been performed from the operation receiver 24, the terminal list manager 22 reads terminal path names from the terminal list stored in the terminal list storage unit 21, and outputs the read terminal path names to the display information generator 28. Upon receiving information that a user operation for inputting a character string on the network reference mode screen has been performed from the operation receiver 24, the terminal list manager 22 searches for a terminal path name including the input character string from the terminal list stored in the terminal list storage unit 21. If a search has succeeded, the terminal list manager 22 updates the terminal list stored in the terminal list storage unit 21, and outputs the searched terminal path name or alert information to the display information generator 28 in accordance with whether or not the searched terminal path name exists in a master browser. If a search has failed, in accordance with whether or not a terminal path name including the character string exists in the master browser, the terminal list manager 22 updates the terminal list stored in the terminal list storage unit 21 and outputs the terminal path name or alert information to the display information generator 28.

The image obtaining unit 23 obtains image data read by the image reader 16 from the HDD 14 (see FIG. 2).

The operation receiver 24 receives a user operation performed on the operation panel 15 (see FIG. 2). More specifically, upon receiving a user operation for inputting a character string on the network reference mode screen, the operation receiver 24 outputs information that a character string has been input to the terminal list manager 22. Upon receiving a user operation for selecting a target terminal path name from a terminal list on the network reference mode screen, the operation receiver 24 outputs information that a target terminal path name has been selected to the display information generator 28. Upon receiving a user operation for setting a terminal path name selected on the network reference mode screen, the operation receiver 24 outputs information that a terminal path name has been set to the sending information generator 25. In this exemplary embodiment, the operation receiver 24 is provided as an example of an obtaining unit for obtaining a character string.

The sending information generator 25 generates sending information to be sent by the sender 26. More specifically, upon receiving information that terminal path names including an input character string have been searched for from the terminal list manager 22, the sending information generator 25 generates information indicating a request to obtain a list of terminal path names. Upon receiving information that a user operation for setting a selected terminal path name has been performed from the operation receiver 24, the sending information generator 25 generates sending information indicating an image obtained by the image obtaining unit 23.

The sender 26 sends sending information generated by the sending information generator 25. More specifically, if sending information indicating a request to obtain a list of terminal path names has been generated by the sending information generator 25, the sender 26 sends this sending information to the master browser. If sending information indicating an image obtained by the image obtaining unit 23 has been generated by the sending information generator 25, the sender 26 sends this sending information to the terminal device 40 indicated by a selected terminal path name.

The receiver 27 receives information from another device. More specifically, the receiver 27 receives a terminal path name from a master browser and an IP address from a domain name system (DNS) server. The receiver 27 also receives a list of terminal path names from the master browser in response to a request to obtain a list of terminal path names.

The display information generator 28 generates display information indicating a screen which is controlled by the display controller 29 so that the screen will be displayed on the operation panel 15 (see FIG. 2). More specifically, upon receiving a terminal path name from the terminal list manager 22, the display information generator 28 generates display information indicating a network reference mode screen including the received terminal path name. Upon receiving, from the operation receiver 24, information that a user operation for selecting a target terminal path name from a terminal list has been performed, the display information generator 28 generates display information indicating a network reference mode screen in which the selected terminal path name is set in the storage destination input field 33 (see FIGS. 4 through 7).

The display controller 29 performs control so that a screen based on display information generated by the display information generator 28 will be displayed on the operation panel 15 (see FIG. 2). For example, the display controller 29 performs control so that a network reference mode screen including a terminal path name will be displayed. In this exemplary embodiment, a terminal path name is used as an example of identification information for identifying a candidate of a destination to which an image is sent, and the display controller 29 is provided as an example of a display unit for displaying identification information.

The above-described elements of the storage destination decision assisting device 20 are implemented by a cooperative operation of software and hardware resources. More specifically, as a result of the CPU 11 (see FIG. 2) reading a program implementing the terminal list storage unit 21, the terminal list manager 22, the image obtaining unit 23, the operation receiver 24, the sending information generator 25, the sender 26, the receiver 27, the display information generator 28, and the display controller 29 from the ROM 13 (see FIG. 2) into the RAM 12 (see FIG. 2) and executing the program, these elements are implemented.

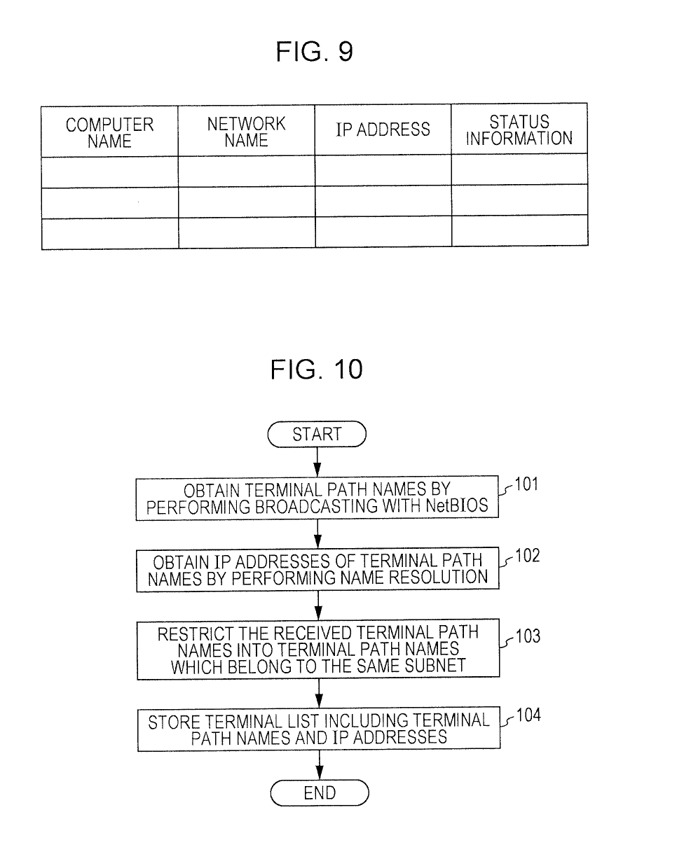

FIG. 9 illustrates an example of a terminal list stored in the terminal list storage unit 21. As shown in FIG. 9, the terminal list includes a computer name, a network name, an IP address, and status information.

The computer name is a name for identifying the terminal device 40 in the Windows (registered) network. The network name is a name for identifying a network group in the Windows (registered) network. As described above, in this specification, a name constituted by a network name and a computer name in this order is called a terminal path name. The IP address is an IP network address allocated to a terminal device 40 specified by the corresponding terminal path name. The status information is information indicating whether or not a terminal device 40 was accessible when verification processing was conducted in the previous time, that is, whether or not the terminal device 40 existed in the master browser. That is, in the terminal list, the terminal path name, the IP address, and information indicating whether or not access to a terminal device 40 is possible are included, and the share name and information concerning the lower levels than the share name are not included.

In the terminal list, not all the terminal devices 40 managed by the master browser are included, but only the terminal devices 40 having a higher priority are included. Items of information concerning the terminal devices 40 included in the terminal list are arranged in order of priority. A higher priority is given to information concerning terminal devices 40 belonging to the same subnet as that of the image reading apparatus 10. A higher priority is also given to information concerning terminal devices 40 which are used more frequently. In contrast, a lower priority may be given to information concerning terminal devices 40 having a computer name which remains as a default name and has not been changed. A higher priority may also be given to information concerning terminal devices 40 which are determined to be close to each other in a network as a result of combining items of information concerning subnets. A higher priority may also be given to information concerning a terminal device 40 which appears earlier in alphabetical order. The priority may be set in accordance with the network name. The setting of priorities may be performed by each image reading apparatus 10.

In the terminal list, user information concerning which user has used which terminal device 40 is not included. Accordingly, the terminal list may be stored even after the image reading apparatus 10 is powered OFF. Information concerning terminal devices 40 in the terminal list may be updated at a desired timing. For example, information concerning terminal devices 40 may be updated at a timing at which access is made to this information. Alternatively, information concerning terminal devices 40 may be updated at a predetermined time or at predetermined regular intervals. As the predetermined time, a desired time within a period for which the terminal devices 40 are operated (working hours) may be set. As the predetermined regular intervals, a default value (for example, every hour) may be set. Conversely, while the image reading apparatus 10 is performing processing, the terminal list may not be updated in order to reduce the load.

The format of the terminal list may be a comma-separated values (CSV) format, an extensible markup language (XML) format, or an array format.

[Operation of Storage destination Decision Assisting Device]

FIG. 10 is a flowchart illustrating an example of an operation for creating a terminal list by the storage destination decision assisting device 20 according to this exemplary embodiment. This operation is started upon startup of the image reading apparatus 10.

In step 101, in the storage destination decision assisting device 20, the sender 26 first performs broadcasting by using NetBIOS, and the receiver 27 receives terminal path names of terminal devices 40 in response to broadcasting of the sender 26.

Then, in step 102, the sender 26 sends a name resolution request to obtain the addresses of these terminal path names to a DNS server, and the receiver 27 receives the IP addresses of the terminal devices 40 in response to this name resolution request.

Then, in step 103, upon receiving the terminal path names and the IP addresses from the receiver 27, the terminal list manager 22 selects the terminal path names of terminal devices 40 which belong to the same subnet as that of the image reading apparatus 10, on the basis of the received IP addresses. Alternatively, the terminal list manager 22 may divide the received terminal path names into the terminal path names of terminal devices 40 which belong to the same subnet as that of the image reading apparatus 10 and the terminal path names of terminal devices 40 which belong to subnets other than the subnet of the image reading apparatus 10. Then, in step 104, the terminal list manager 22 stores a terminal list of the selected terminal path names and the associated IP addresses in the terminal list storage unit 21.

In this state, it is assumed that a user reads an image and displays a network reference mode screen for deciding a storage destination of the image data. Then, in the storage destination decision assisting device 20, the terminal list manager 22 reads the terminal path names from the terminal list stored in the terminal list storage unit 21 and outputs them to the display information generator 28. Then, the display information generator 28 generates display information for displaying the terminal path names received from the terminal list manager 22. The display controller 29 then performs control so that the terminal path names will be displayed in the terminal list display field 34 (see FIGS. 4 through 7) of the network reference mode screen on the basis of the display information.

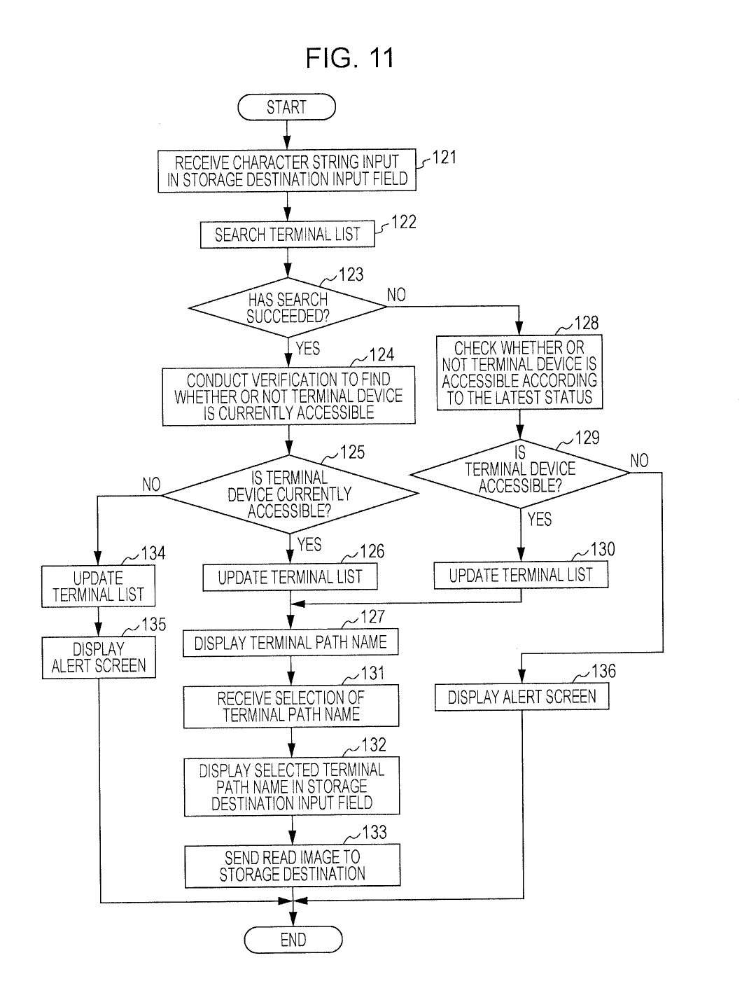

FIG. 11 is a flowchart illustrating an example of an operation for using a terminal list stored in the storage destination decision assisting device 20. As discussed above, even if terminal path names are displayed in the terminal list display field 34 (see FIGS. 4 through 7) of a network reference mode screen, it may not be possible to find a target terminal path name from the displayed terminal path names. In this case, the user inputs a character string in the storage destination input field 33 (see FIGS. 4 through 7). The operation shown in FIG. 11 is started upon input of a character string.

In step 121, in the storage destination decision assisting device 20, the operation receiver 24 receives a character string input in the storage destination input field 33.

Then, in step 122, the terminal list manager 22 receives the character string from the operation receiver 24, and searches for a terminal path name from a terminal list stored in the terminal list storage unit 21 by using this character string as a search key. The terminal list manager 22 then determines in step 123 whether or not a search has succeeded.

If it is determined in step 123 that a search has succeeded, the process proceeds to step 124. In step 124, the storage destination decision assisting device 20 conducts verification processing regarding whether or not the terminal device 40 specified by the searched terminal path name is currently accessible. More specifically, the sending information generator 25 first generates sending information indicating a request to obtain a list of terminal path names, and the sender 26 then sends this sending information to a master browser. Then, the receiver 27 receives a list of terminal path names from the master browser, and the terminal list manager 22 searches for the searched terminal path name from this list. Alternatively, in this case, since the full path is identified, the storage destination decision assisting device 20 may directly access this terminal device 40 to conduct verification processing regarding whether or not the terminal device 40 is currently accessible.

Then, in the storage destination decision assisting device 20, the terminal list manager 22 determines in step 125 whether or not the terminal device 40 specified by the searched terminal path name is currently accessible. More specifically, the terminal list manager 22 determines whether or not the searched terminal path name is included in the list received in step 124.

If it is determined in step 125 that the terminal device 40 is currently accessible, the process proceeds to step 126. In step 126, the terminal list manager 22 updates the terminal list. More specifically, the terminal list manager 22 first stores information that the terminal device 40 indicated by the searched terminal path name is accessible, as status information concerning this terminal path name in the terminal list. The terminal list manager 22 also moves up the order of this terminal path name in the terminal list so as to increase its priority. Then, if the priority of the terminal path name is increased in this manner, next time this terminal path name is displayed, it will be listed at a higher level than it is this time. In this case, “a higher level” is not restricted to the upper side of the network reference mode screen, but refers to a position at which a terminal path name having a higher priority is displayed in a terminal list.

Then, in step 127, the storage destination decision assisting device 20 displays the searched terminal path name. More specifically, the terminal list manager 22 first outputs the terminal path name searched from the terminal list to the display information generator 28. Then, the display information generator 28 generates display information for displaying a network reference mode screen including this terminal path name. Then, the display controller 29 performs control so that the network reference mode screen will be displayed on the basis of this display information.

On the other hand, if it is determined in step 123 that a search has not succeeded, the process proceeds to step 128. In step 128, the storage destination decision assisting device 20 checks whether or not the terminal device 40 specified by the terminal path name including the character string used in conducting a search is accessible according to the latest status. More specifically, the sending information generator 25 first generates sending information indicating a request to obtain a list of terminal path names, and the sender 26 then sends this sending information to the master browser. Then, the receiver 27 receives a list of terminal path names from the master browser, and the terminal list manager 22 searches for a terminal path name including the character string from this list.

Then, in the storage destination decision assisting device 20, the terminal list manager 22 determines in step 129 whether or not the terminal device 40 specified by the terminal path name including the character string is accessible according to the latest status. More specifically, the terminal list manager 22 determines whether or not the terminal path name including the character string is included in the list received in step 128.

If it is determined in step 129 that the terminal device 40 including the character string is accessible according to the latest status, the process proceeds to step 130. In step 130, the terminal list manager 22 updates the terminal list. More specifically, the terminal list manager 22 first stores information that the terminal device 40 indicated by this terminal path name was accessible, as status information for this terminal path name in the terminal list. The terminal list manager 22 also adds this terminal path name searched from the list of terminal path names to the terminal list. The terminal list manager 22 also moves up the order of this terminal path name in the terminal list so as to increase its priority. If the priority of the terminal path name is increased in this manner, next time this terminal path name is displayed, it will be listed at a higher level than it is this time. In this case, “a higher level” is not restricted to the upper side of the network reference mode screen, but refers to a position at which a terminal path name having a higher priority is displayed in the terminal list.

Then, in step 127, the storage destination decision assisting device 20 displays the searched terminal path name. More specifically, the terminal list manager 22 first outputs the terminal path name searched from the list of the terminal path names to the display information generator 28. Then, the display information generator 28 generates display information for displaying a network reference mode screen including this terminal path name. Then, the display controller 29 performs control so that the network reference mode screen will be displayed on the basis of this display information.

Then, in step 131, when the user performs an operation for selecting the terminal path name of the terminal device 40 as a storage destination from the terminal path names included in the terminal list, the operation receiver 24 receives this operation.

Then, in step 132, the storage destination decision assisting device 20 sets the selected terminal path name in the storage destination input field 33. More specifically, the display information generator 28 first receives the selected terminal path name from the operation receiver 24, and generates display information for displaying a network reference mode screen in which the terminal path name is set in the storage destination input field 33. Then, the display controller 29 performs control so that the network reference mode screen will be displayed on the basis of this display information.

In step 133, when the user performs an operation for setting the terminal device 40 specified by the terminal path name set in the storage destination input field 33 as a storage destination, the storage destination decision assisting device 20 sends the image read by the image reader 16 to the terminal device 40, which is the storage destination. More specifically, when the user performs an operation for setting the terminal device 40 specified by the terminal path name set in the storage destination input field 33 as a storage destination, the operation receiver 24 receives this operation. Then, upon receiving information that the terminal device 40 is set as a storage destination from the operation receiver 24, the sending information generator 25 generates sending information indicating the image obtained by the image obtaining unit 23. Then, the sender 26 sends the sending information to the terminal device 40, which is the storage destination.

If it is determined in step 125 that the terminal device 40 specified by the searched terminal path name is not currently accessible, the process proceeds to step 134. Even in this case, in step 134, the terminal list manager 22 updates the terminal list. More specifically, the terminal list manager 22 stores information that this terminal path name was not accessible, as status information for this terminal path name in the terminal list. The terminal list manager 22 also moves up the order of this terminal path name in the terminal list so as to increase its priority. In this manner, there may be a case in which a certain terminal path name does not exist in a master browser despite that it exists in a terminal list. One of the reasons for this may be because the power of the terminal device 40 specified by this terminal path name was ON when the terminal list was created, but is currently OFF. Thus, in this exemplary embodiment, even if a terminal path name in a terminal list does not exist in a master browser, it is not deleted. On the contrary, the priority of this terminal path name is increased, assuming that it may be used again. By increasing the priority of such a terminal path name, next time this terminal path name is displayed, it will be listed at a higher level than it is this time. In this case, “a higher level” is not restricted to the upper side of the network reference mode screen, but refers to a position at which a terminal path name having a higher priority is displayed in a terminal list.

Then, in step 135, the storage destination decision assisting device 20 displays an alert screen. More specifically, the terminal list manager 22 outputs alert information indicating, for example, “make sure that the terminal device is ON”, to the display information generator 28. Then, the display information generator 28 generates display information for displaying an alert screen including this alert information. Then, the display controller 29 performs control so that an alert screen will be displayed on the basis of this display information.

If it is determined in step 129 that a terminal path name including the character string does not exist in the master browser, the process proceeds to step 136. In step 136, the storage destination decision assisting device 20 displays an alert screen without updating the terminal list. More specifically, the terminal list manager 22 outputs alert information indicating, for example, “the target terminal device have not been found”, to the display information generator 28. Then, the display information generator 28 generates display information for displaying an alert screen including this alert information. Then, the display controller 29 performs control so that an alert screen will be displayed on the basis of this display information.

In this exemplary embodiment, after a network reference mode screen has appeared, a target terminal device 40 is selected as shown in FIGS. 4 through 7. However, while inputting a server name or an IP address in the screen shown in FIG. 3, a user may press the network reference button 32 to switch to the network reference mode. With this modification, if the user has input until “¥¥net00¥pc88888-” and does not remember whether “01”, “02”, or “03” will follow, the user is able to switch to the network reference mode and conducts a search by using a character string.

In this exemplary embodiment, it is not assumed that, after a user has selected a target terminal device 40 in the network reference mode screen shown in FIGS. 4 through 7, the user changes the terminal path name by adding or rewriting a character string. However, the user may change a terminal path name. For example, it is assumed that, although “¥¥net00¥pc88888-03” is displayed in the terminal list display field 34 shown in FIG. 4, the target terminal device 40 is not “pc88888-03”, but “pc88888-04”. In this case, after selecting “¥¥net00¥pc88888-03”, the user may change from “03” to “04” in the storage destination input field 33. With this arrangement, the number of characters the user has to input is reduced, compared with a case in which the user inputs the entirety of a terminal path name which is not included in a list all again.

The program implementing this exemplary embodiment may be provided by using a communication medium or by storing it in a recording medium, such as a compact disc—read only memory (CD-ROM).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image reading apparatus comprising:
a reading unit configured to read an image from a recording medium on which the image is recorded;
an obtaining unit configured to obtain a character string input by an operator;
a display unit configured to display a plurality of items of identification information for identifying a plurality of candidates of a destination to which the image is to be sent and to display, upon obtaining the character string, at least one item of identification information including the character string, instead of displaying the plurality of items of identification information; and
a sending unit configured to send the image to a destination identified by an item of identification information set by the operator among the at least one item of identification information,
wherein,
each of the plurality of items of identification information includes a network name and a computer name of a plurality of levels of a hierarchy, and
the display unit is configured to display identification information including a network name or a computer name of one of the levels of the hierarchy which includes the character string, as the at least one item of identification information, and
wherein the display unit is configured to display the plurality of items of identification information stored in the information processing apparatus, and upon obtaining the character string, if the at least one item of identification information is stored in the information processing apparatus and is verified in a network, the display unit is configured to display the at least one item of identification information instead of displaying the plurality of items of identification information.

2. An information processing apparatus comprising:
an obtaining unit configured to obtain a character string input by an operator; and
a display unit configured to display a plurality of items of identification information for identifying a plurality of candidates of a destination to which an image read by an image reading apparatus is sent and that displays, upon obtaining the character string, at least one item of identification information including the character string, instead of displaying the plurality of items of identification information,
wherein the display unit is configured to display the plurality of items of identification information stored in the information processing apparatus, and upon obtaining the character string, if the at least one item of identification information is stored in the information processing apparatus and is verified in a network, the display unit is configured to display the at least one item of identification information instead of displaying the plurality of items of identification information.

3. The information processing apparatus according to claim 2, wherein:
each of the plurality of items of identification information includes a network name and a computer name of a plurality of levels of a hierarchy; and
the display unit is configured to display identification information including a network name of the highest level of the hierarchy which starts with the character string, as the at least one item of identification information.

4. The information processing apparatus according to claim 2, wherein:
each of the plurality of items of identification information includes a network name and a computer name of a plurality of levels of a hierarchy; and
the display unit is configured to display identification information including a network name or a computer name of one of the levels of the hierarchy which includes the character string, as the at least one item of identification information.

5. The information processing apparatus according to claim 2, wherein the display unit is configured to display the plurality of items of identification information including identification information for identifying a destination belonging to a subnet to which the image reading apparatus belongs.

6. The information processing apparatus according to claim 2, wherein, when displaying the plurality of items of identification information after displaying the at least one item of identification information, the display unit is configured to display the at least one item of identification information at a higher position than a display position of the at least one item of identification information in a previous time.

7. (canceled)

8. The information processing apparatus according to claim 2, wherein the display unit is configured to display the plurality of items of identification information stored in the information processing apparatus, and upon obtaining the character string, if the at least one item of identification information is stored in the information processing apparatus and is not verified in a network, the display unit is configured to display notification information that the at least one item of identification information is not verified in a network.

9. The information processing apparatus according to claim 8, wherein, when displaying the plurality of items of identification information after displaying the notification information, the display unit does not delete the at least one item of identification information from the information processing apparatus and is configured to display the at least one item of identification information at a higher position than a display position of the at least one item of identification information in the past.

10. A non-transitory computer readable medium storing a program causing a computer to execute a process, the process comprising:
obtaining a character string input by an operator; and
displaying a plurality of items of identification information for identifying a plurality of candidates of a destination to which an image read by an image reading apparatus is sent and displaying, upon obtaining the character string, at least one item of identification information including the character string, instead of displaying the plurality of items of identification information,
wherein the displaying the plurality of items of identification information comprises, if the at least one item of identification information is verified in a network, displaying the at least one item of identification information instead of displaying the plurality of items of identification information.
